(19) United States
(12) Patent Application Publication
(10) Pub. No.: US 2011/0227987 A1
(43) Pub. Date: Sep. 22, 2011

(54) THERMAL INKJET PRINTHEAD FEED TRANSITION CHAMBER AND METHOD OF COOLING USING SAME

(76) Inventors: Alfred I-Tsung Pan, Sunnyvale, CA (US); Daniel Fradl, Palo Alto, CA (US); Erik D. Torniainen, Albany, OR (US)

(21) Appl. No.: 13/124,085

(22) PCT Filed: Oct. 30, 2008
(86) PCT No.: PCT/US08/81877

§ 371 Date: Apr. 13, 2011

(51) Int. Cl. B41J 29/377; B41J 2/05

(52) U.S. Cl. 347/18; 347/65

(57) ABSTRACT

A thermal inkjet printhead and a method of cooling convectively cool the printhead with ink passing through a feed transition chamber. The thermal inkjet printhead includes a bridge beam and feed channels adjacent to the bridge beam. The printhead further includes a feed transition chamber between inputs to the feed channels and an ink reservoir. The ink flows through the feed transition chamber between the ink reservoir and the feed channels to convectively cool. The method of cooling includes providing the feed transition chamber and flowing ink through the feed transition chamber from the ink reservoir to the feed channels. The flowing ink establishes a temperature gradient between walls of the feed transition chamber and the ink. The temperature gradient facilitates convective cooling of the printhead.

### CROSS-REFERENCE TO RELATED APPLICATIONS

N/A

### STATEMENT REGARDING FEDERALLY SPONSORED RESEARCH OR DEVELOPMENT

N/A

### BACKGROUND

1. Technical Field

The invention relates to thermal inkjet devices. In particular, the invention relates to an inkjet printhead used with thermal inkjet devices.

2. Description of Related Art

Inkjet printers and related inkjet devices have proven to be reliable, efficient, and generally cost effective means for the accurate delivery of precisely controlled amounts of ink and other related liquid materials onto various substrates such as, but not limited to, glass, paper, cloth, transparencies and related polymer films. For example, modern inkjet printers for consumer market digital printing on paper offer printing resolutions in excess of 2400 dots per inch (DPI), provide printing speeds greater than 20-30 sheets per minute, and deliver individual droplets of ink in a ‘drop-on-demand’ method that are often measured in picoliters. The relatively low costs, high print quality and generally vivid color output provided by these modern inkjet printers has made these printers the most common digital printer in the consumer market. Currently, in addition to the consumer market, there is considerable interest in employing inkjet printing for high speed commercial and industrial applications.

In general, inkjet printheads used for drop-on-demand inkjet printers and related inkjet printing systems may employ one of at least two technologies for ejecting droplets of ink. A first of these technologies employs a piezoelectric effect or a piezoelectric-based ejector element to eject the droplets from the printhead. The second of these technologies, often referred to as thermal inkjet printing, employs localized heat produced by the ejector element to vaporize a portion of the ink. A bubble produced by the vaporization expands to eject a remaining portion of the ink from the inkjet to printhead as the droplet.

A limiting factor in the operation of thermal inkjet printers is removal of excess heat generated during ink ejection from inkjet printhead. In particular, overheating of the inkjet printhead may effectively limit a maximum ejection or firing frequency as well as place constraints on a type and general makeup of inks employed for thermal inkjet printing. As such, there has been and continues to be considerable interest in means for controlling and ultimately removing this heat from the thermal inkjet printhead. Such means for heat removal or cooling of the inkjet printheads would satisfy a long felt need.

### BRIEF DESCRIPTION OF THE DRAWINGS

The various features of embodiments of the present invention may be more readily understood with reference to the following detailed description taken in conjunction with the accompanying drawings, where like reference numerals designate like structural elements, and in which:

FIG. 1 illustrates across sectional view of a thermal inkjet printhead, according to an embodiment of the present invention.

FIG. 2 illustrates a perspective view of a thermal inkjet printhead, according to an embodiment of the present invention.

FIG. 3 illustrates a flow chart of a method of cooling a printhead in a thermal inkjet system, according to an embodiment of the present invention.

### DETAILED DESCRIPTION

Embodiments Of the present invention facilitate removing heat from a thermal inkjet printhead in an ink jet device, printer or system using convective cooling. The convective cooling effectively extracts heat from a body of the printhead and transfers the heat to ink being ejected by and from the printhead. Embodiments of the present invention provide an improved thermal coupling between the printhead body and the ink when compared to conventional printhead configurations. Further, a comparatively stronger thermal gradient is promoted within the ink and across an ink-to-body interface by a flow of the ink that further facilitates heat flux between the body and the ink, according to various embodiments of the present invention. The convective cooling facilitated by the embodiments of the present invention may allow for higher firing frequencies and lower overall ink temperatures to be achieved, for example.

In conventional thermal inkjet printhead configurations, an ejection element ejects ink as droplets from a nozzle of the printhead. The ejection element (e.g., a resistive heater) is typically located in a bubble expansion chamber below the nozzle. The ejector element forms a bubble in the bubble expansion chamber. The bubble expands to eject the ink. Ink for ejection is supplied from an ink reservoir through a feed channel to the bubble expansion chamber. The ink reservoir is in direct communication with the feed channel in a conventional configuration.

A primary means for cooling the thermal inkjet printhead is heat transfer from the body of the printhead to the ink being ejected. The heat transfer or heat flux occurs primarily within the feed channel and bubble expansion chamber. In particular, heat flux crosses the walls of the feed channel and enters the ink as the ink is drawn through the feed channel from the ink reservoir. Additional heat flux enters the ink within the bubble expansion chamber as the ink is ejected through the nozzle. Comparatively little heat is transferred from the printhead body to ink in the ink reservoir. As such, the ink in the feed channel and bubble expansion chamber is relatively hot (often near a steady state temperature of the printhead) while ink in the ink reservoir is relatively cooler during operation of the printhead.

According to various embodiments of the present invention, a feed transition chamber is provided between the ink reservoir and one or more feed channels of the printhead. Ink flowing from the ink reservoir must, therefore, flow through the feed transition chamber before entering the feed channel. The feed transition chamber has a width that is smaller than a width of the ink reservoir. For example, the feed transition chamber may have a width that is several times smaller than the width of the ink reservoir.

The smaller width of the feed transition chamber increases a contact between the ink and the printhead body. In particular, a ratio of a wall area of the feed transition chamber to a volume of ink within the feed transition chamber is greater than a wall area to ink volume ratio within the ink reservoir. The increased ratio allows for to increased direct contact between the ink and the walls than is typically present in the ink reservoir. A resultant capacity for communicating heat (i.e., heat flux capacity) from the printhead body to the ink is increased for the feed transition chamber relative to that afforded by the ink reservoir. The increased heat flux capacity provided by the feed transition chamber embodiments of the present invention results in an improved convective cooling of the printhead compared to the conventional printhead configurations.

In addition, a thermal gradient within the ink and between the ink and the feed transition chamber walls is increased when compared to a convention a printhead lacking a feed transition chamber, according to various embodiments of the present invention. In particular, a flow velocity of the ink in the ink transition chamber is increased relative to an ink flow velocity in the ink reservoir. The relative increase in ink flow velocity is primarily due to the relatively smaller volume of the ink transition chamber as compared to that of the ink reservoir. The increase flow velocity moves ink by any particular point on the wall of the feed transition chamber more rapidly. As a result, ink adjacent to the particular point on the wall of the feed transition chamber is relatively cooler. The cooler ink provides a larger or more pronounced thermal gradient. The increased thermal gradient improves an ability of heat to move from the printhead body into the ink flowing through the feed transition chamber. Hence, the increased flow velocity and concomitant increased thermal gradient further facilitates convective cooling.

In some embodiments, a plurality of feed channels is provided. The plurality of feed channels connects between the feed transition chamber and the bubble expansion chamber. Feed channels of the plurality are relatively longer and have a smaller cross sectional area (i.e., relatively narrower) than the conventional feed channel. The relatively longer and narrower feed channels of the plurality provide a contact between the ink and the printhead that adds to that provided by the feed transition chamber. The added contact provided by the plurality of feed channels further enhances the heat flux capacity and the resultant improved convective cooling.

In addition, the plurality of feed channels further constrain or narrow a local flow path or flow volume. The narrowed local flow path in the feed channels of the plurality further increases the ink flow velocity relative to the flow velocity in the feed transition chamber. As with the feed transition chamber, the increased ink flow velocity within the plurality of feed channels provides a larger or more pronounced thermal gradient. The larger thermal gradient improves the ability of heat to move from the printhead body into the ink flowing through the feed channels. The increased flow velocity and concomitant larger thermal gradient provided by the plurality of feed channels according to embodiments of the present invention further facilitate convective cooling.

Embodiments of the present invention employ a bridge beam architecture. In such embodiments, the printhead further comprises a bridge beam that supports the ejector element within the bubble expansion chamber. The bridge beam is a structure that spans from a back to a front of the bubble expansion chamber effectively forming a bottom of the bubble expansion chamber, according to some embodiments. Sides of the bridge beam are delineated by either a sidewall of the bubble expansion chamber or a feed channel. For example, a pair of feed channels may delineate a first side and a second side of the bridge beam.

The bridge beam may comprise a material (e.g., silicon) of the body of the printhead, in some embodiments. In other embodiments, the bridge beam may comprise a metal such as, but not limited copper (Cu) or tungsten (W). In yet other embodiments, the bridge beam may comprise an oxide such as, but not limited to, silicon dioxide (SiO₂).

In some embodiments, the bridge beam further separates the bubble expansion chamber from the feed transition chamber. In particular, a top of the feed transition chamber is in contact with a bottom of the bridge beam, in some embodiments. As such, a thickness of the bridge beam may essentially establish a distance between the feed transition chamber and the bubble expansion chamber.

As used herein, the article ‘a’ is intended to have its ordinary meaning in the patent arts, namely ‘one or more’. For example, ‘a layer’ generally means one or more layers and as such, ‘the layer’ means ‘the layer(s)’ herein. Also, any reference herein to ‘top’, ‘bottom’, ‘upper’, ‘lower’, ‘up’, ‘down’, ‘left’ or ‘right’ is not intended to he a limitation herein. Moreover, examples herein are intended to he illustrative only and are presented for discussion purposes and not by way of limitation.

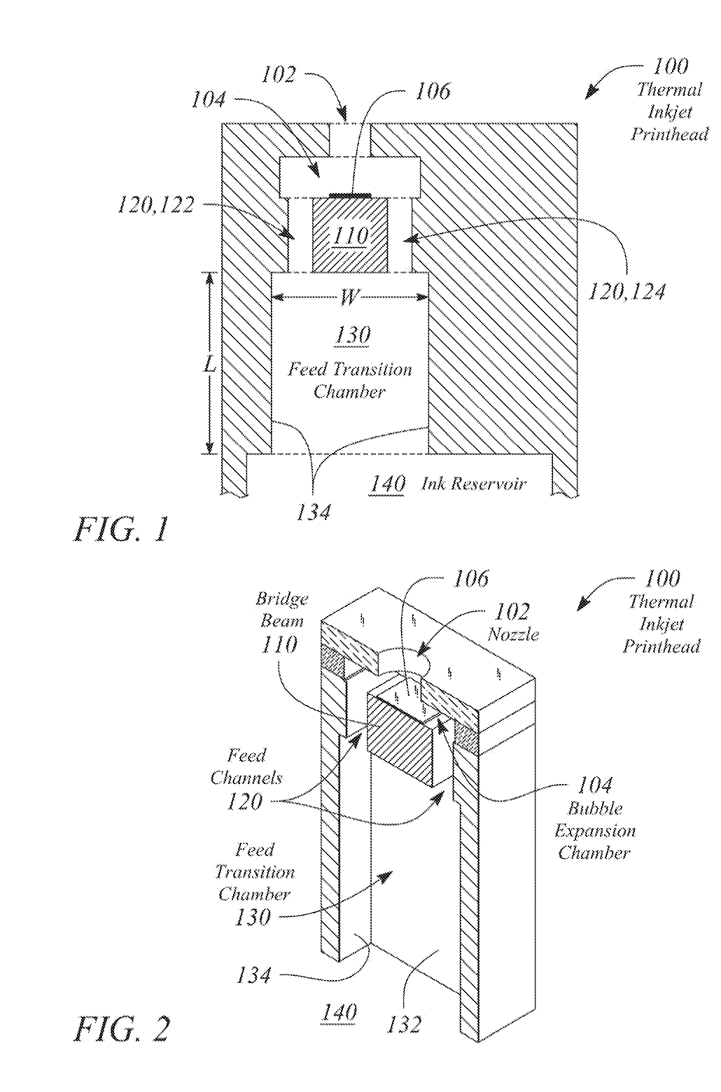

FIG. 1 illustrates a cross sectional view of a thermal inkjet printhead 100, according to an embodiment of the present invention. FIG. 2 illustrates a cut-away perspective view of a thermal inkjet printhead 100, according to an embodiment of the present invention. During operation, the printhead 100 ejects ink as droplets (not illustrated) from a nozzle 102. The ink is ejected from the nozzle 102 by an expanding bubble in a bubble expansion chamber 104 below (e.g., below as illustrated) the nozzle 102, for example.

The expanding bubble is created during operation by an ejector element 106. As illustrated, the ejector element 106 is located at a bottom of the bubble expansion chamber 104. In some embodiments, the ejector element 106 comprises a heater 106. For example, the heater 106 may comprise a resistor that heats up when a current flows through the resistor. During operation of the printhead 100, the heater 106 applies heat to the ink within the bubble expansion chamber 104. A portion of the ink is vaporized by the heat and forms the expanding bubble. The expanding bubble then forces ink remaining in a liquid form above the bubble out of the bubble expansion chamber 104 through the nozzle 102. A principle source of excess heat in the printhead 100 is produced by the heater 106.

According to various embodiments of the present invention, the thermal inkjet printhead 100 comprises a bridge beam 110. The bridge beam 110 spans across a portion of the bottom of the bubble expansion chamber 104. The bridge beam 110 further supports the ejector element 106. In some embodiments, the bridge beam 110 comprises an area essentially equivalent to an area of the ejector element 106. In some embodiments, the bridge beam 110 is relatively thick. For example, the bridge beam 110 may have a thickness that is greater than about 10 microns (μm). In some embodiments, the bridge beam 110 may be between 10 μm and about 100 μm thick. For example, the bridge beam 110 may be about 15-25 μm thick.

In some embodiments, the bridge beam 110 comprises a material of the printhead 100 or of a body of the printhead (not separately labeled in FIG. 1). For example, the body of the printhead 100 and the bridge beam 110 may comprise silicon (Si). In other embodiments, the bridge beam 110 may comprise a material, that exhibits good heat conductivity. In particular, in such embodiments, the bridge beam 110 may comprise a material other than or in addition to the material of the printhead 100 body. For example, the other material may be chosen to have a thermal conductivity that is higher than the printhead 100 body. The printhead 100 may comprise Si while the bridge beam 110 may comprise a metal known to have a higher thermal conductivity than Si such as, but not limited to, copper (Cu) and tungsten (W), for example.

The thermal inkjet printhead 100 further comprises a plurality of ink inlet or feed channels 120 adjacent to the bridge beam 110. In some embodiments, the plurality of feed channels 120 is disposed on either side of the bridge beam 110 at the base of the bubble expansion chamber 104. In some of these embodiments, the plurality of feed channels 120 is symmetrically disposed on either side of the bridge beam 110. The plurality of feed channels 120 provides a conduit for supplying ink to the bubble expansion chamber 104. In some embodiments, a volume of the plurality of feed channels is between about 0.5 to about 10.0 times a volume of the bubble expansion chamber 104 and the nozzle 102. In some embodiments, a volume of the plurality of feed channels is between about 0.5 to about 2.0 times a volume of the bubble expansion chamber 104 and the nozzle 102.

For example, as illustrated in FIGS. 1 and 2, a first feed channel 122 is located on a first side of the bridge beam 110 while a second feed channel 124 is located on a second side of the bridge beam 110. Further as illustrated, the exemplary first feed channel 122 and exemplary second feed channel 124 are symmetrically located on and extend along opposite sides of the bridge beam 110. In particular, as is illustrated in FIG. 2, the first and second feed channels 122, 124 are essentially rectangular holes in a bottom of the bubble expansion chamber 104. The first and second feed channels 122, 124 essentially define the sides to the bridge beam 110.

In some embodiments (e.g., as illustrated), the feed channels 120 of the plurality have a length that is essentially equal to the thickness of the bridge beam 110. For example, a thickness of the bridge beam 110 and a length of the feed channels 120 of the plurality may be greater than about 10 μm and less than about 100 μm.

The thermal inkjet printhead 100 further comprises a feed transition chamber 130 below the bridge beam 110. The feed transition chamber 130 connects to an input end of each of the feed channels 120 of the plurality. The feed transition chamber 130 has a width that spans the plurality of feed channels 120. The feed transition chamber 130 has a length that is greater than its width.

In some embodiments, the width of the feed transition chamber 130 is greater than a distance between opposing outer edges of feed channels 120 of the plurality disposed on opposite sides of the bridge beam 110. In some embodiments, the width of the feed transition chamber 130 is less than about two times (2×) the distance between opposing outer edges of feed channels 120 of the plurality disposed on opposite sides of the bridge beam 110.

Walls of the feed transition chamber 130 provide a path for heat flux between a body of the printhead 100 and ink within the feed transition chamber 130. This heat flux convectively cools the printhead 100 by transferring heat from the printhead 100 body into ink flowing through the feed transition chamber 130 and into the feed channels 120.

In some embodiments, the walls of the feed transition chamber 130 are substantially parallel to one another. For example, a front wall (not illustrated) may be parallel to and offset from a back wall 132. In particular, the offset may be essentially a depth of the feed transition chamber 130. Similarly, side walls 134 may be essentially parallel to one another. By definition herein, the side walls 134 are offset from one another by a distance equal to the width of the feed transition chamber 130. The length of the feed transition chamber 130 is further defined as a length of the side walls 134, in some embodiments.

As illustrated in FIGS. 1 and 2, the feed transition chamber 130 is located below the bridge beam 110. As such, the feed transition chamber 130 essentially defines a bottom of the bridge beam 110. In particular, a top end of the feed transition channel 130 comprises a bottom surface of the bridge beam 110. Further as illustrated in FIG. 1, the feed transition channel 130 has a width W that spans the exemplary first and second feed channels 122, 124 disposed on either side of the bridge beam 110. In other words, the width W is greater than a distance between opposing outer edges of the first and second feed channels 122, 124. The distance between opposing outer edges includes a width of the bridge beam 110. A length L of the feed transition chamber 130 exceeds the width W, as illustrated.

In some embodiments, the feed transition chamber 130 may have a width W of between about 30 μm and 120 μm. For example, the feed transition chamber 130 may have a width W of about 50 μm, a length L of about 100 μm and a depth of about 24 μm. In this example, the feed channels 120 may have a rectangular cross section measuring about 10 μm wide by about 20 μm deep. Further for the example, the bridge beam 110 may be about 20 μm wide, 20 μm deep and have a thickness of about 30 μm. Thus, the feed transition chamber 130 width W of 50 μm exceeds (i.e., spans) a combined width of the bridge beam 110 and flanking feed channels 120 of the plurality (i.e., 50 μm>20 μm+10 μm+10 μm). In another example, the feed channels 120 may have a width between about 5 μm and 50 μm and a length of between about 10 μm and about 100 μm. Thus, if the width of the bridge beam is about 20 μm, the width W of the feed transition chamber 130 may vary from about 30 μm to more than 120 μm.

The thermal inkjet printhead 100 further comprises an ink reservoir 140. The ink reservoir 140 serves as a source of ink for the thermal inkjet printhead 100. The ink reservoir 140 is located at a bottom end of the feed transition chamber 130. In particular, the feed transition chamber 130 is between and connects the feed channels 120 and the ink reservoir 140. Ink from the ink reservoir 140 passes through the feed transition chamber 130 on its way to the feed channels 120 during operation of the printhead 100. As noted above, the ink passing from the ink reservoir 140 to the feed channels 120 through the feed transition chamber 130 convectively cools the thermal inkjet printhead 100.

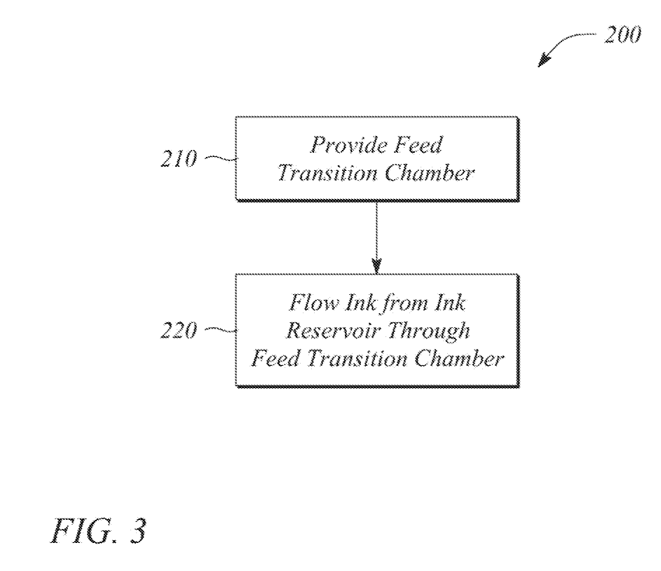

FIG. 3 illustrates a flow chart of a method 200 of cooling a printhead in a thermal inkjet system, according to an embodiment of the present invention. The method 200 of cooling a printhead essentially provides convective cooling of the printhead by transferring heat generated by or in the printhead to ink that flows through and is ejected by the printhead. Cooling the printhead according to embodiments of the method 200 may facilitate operating the printhead one or both of at an increase firing frequency and with ink that is ejected at a relatively cooler temperature, for example.

The method 200 of cooling comprises providing 210 a feed transition chamber between an ink reservoir and a plurality of feed channels of the printhead. The provided 210 feed transition chamber has a width that spans the plurality of feed channels plus a width of a bridge beam. The provided 210 feed transition chamber further has a length that exceeds the width of the feed transition chamber.

In some embodiments, the feed transition chamber may be provided 210 during manufacture of the printhead. For example, the printhead with the provided 210 feed transition chamber may be manufactured from a silicon (Si) block or substrate using conventional semiconductor manufacturing methodologies. The manufacture of the printhead may comprise providing the Si block (e.g., an Si wafer), depositing one or more layers on the Si block and selectively etching the Si block and possibly the deposited layers, for example. In the example, the feed transition chamber may be provided 210 by etching a cavity in the Si block. Examples of printheads and their respective manufacture that may be modified in accordance with the present invention to provide 210 the feed transition chamber of the method 200 of cooling are described in U.S. Pat. Nos. 4,894,664, 6,003,977, and 6,534,247, each of which is incorporated herein by reference in their entirety.

In some embodiments, the provided 210 feed transition chamber is essentially similar to the feed transition chamber 130 described above with reference to the printhead 100. Moreover, the bridge beam, the feed channels and the ink reservoir may be essentially similar, respectively, to the bridge beam 110, the feed channels 120 and ink reservoir 140 described above with respect to the printhead 100, in some embodiments.

The method 200 of cooling a printhead further comprises flowing 220 ink from the ink reservoir through the feed transition chamber to the plurality of feed channels. For example, flowing 220 ink may be a result of replenishing ink in a bubble expansion chamber of the printhead. The replenishment may follow an ejection of the ink by actuation or firing of an ejector element, for example. After the ink is ejected, ink in the feed channels 120 is drawn into and refills the bubble expansion chamber. Ink from the feed transition chamber, in turn, refills the feed channels by drawing ink from the ink reservoir. The ink replenishment over the course of multiple firings essentially results in the flowing 220 of the ink through the feed transition chamber. The flowing 220 ink establishes a temperature gradient between walls of the feed transition chamber and the ink. The temperature gradient facilitates convective cooling of the printhead.

In some embodiments (not illustrated), the method 200 of cooling further comprises operating the printhead in a clear mode. The term ‘clear mode’ refers to a mode of operation in which essentially all of the ink is evacuated from the bubble expansion chamber during firing of the printhead. For a discussion of clear mode operation of thermal inkjet printheads see, for example, the co-pending patent application cited supra, as well as U.S. Pat. No. 6,113,221 which is incorporated in its entirety by reference herein. In some embodiments in which clear mode operation is employed, a volume of a bubble formed during ink ejection essentially equals a volume of an expansion chamber and a volume of a nozzle located above the bridge beam.

Thus, there have been described embodiments of a thermal inkjet printhead and a method of cooling a printhead of a thermal inkjet system that employ a feed transition chamber to convectively cool the printhead. It should be understood that the above-described embodiments are merely illustrative of some of the many specific embodiments that represent the principles of the present invention. Clearly, those skilled in the art can readily devise numerous other arrangements without departing from the scope of the present invention as defined by the following claims.

What is claimed is:

1. A thermal inkjet printhead comprising:
a bridge beam that supports an ejector element within a bubble expansion chamber below a nozzle;
a plurality of feed channels adjacent to the bridge beam;
a feed transition chamber below the bridge beam, the feed transition chamber connecting to an input end the plurality of the feed channels, the feed transition chamber having a width that spans the plurality of feed channels and a length that is greater than the width; and
an ink reservoir, the feed transition chamber connecting between the feed channels and the ink reservoir,
wherein the feed transition chamber provides an ink flow path between the ink reservoir and the feed channels.

2. The thermal inkjet printhead of claim 1, wherein walls of the feed transition chamber provide a path for heat flux between a body of the thermal inkjet printhead and ink within the feed transition chamber to convectively cool the thermal inkjet printhead.

3. The thermal inkjet printhead of claim 1, wherein the feed transition chamber comprises opposing walls that are substantially parallel to one another.

4. The thermal inkjet printhead of claim 1, wherein the width of the feed transition chamber is greater than a distance between opposing outer edges of the feed channels but is less than about twice the distance, the feed channels being on opposite sides of the bridge beam.

5. The thermal inkjet printhead of claim 1, wherein both a thickness of the bridge beam and a length of the feed channels of the plurality are greater than about 10 microns and less than about 100 microns.

6. The thermal inkjet printhead of claim 1, wherein the feed transition chamber has both a width between about 30 microns and about 120 microns.

7. The thermal inkjet printhead of claim 1, wherein a feed channel of the plurality has a width between about 5 μm and about 50 μm and a length of between about 10 μm and about 100 μm.

8. The thermal inkjet printhead of claim 1, wherein the bridge beam comprises one or more of a metal and silicon (Si).

9. The thermal inkjet printhead of claim 1, wherein at least a first feed channel of the plurality is disposed on and extends along a first side of the bridge beam, a second feed channel of the plurality being disposed and extending along a second side of the bridge beam opposite the first side, and wherein a volume of the plurality of feed channels is between about 0.5 to about 10.0 times a volume of the bubble expansion chamber and the nozzle.

10. A printhead of a thermal inkjet system comprising:
a pair of feed channels, the feed channels being adjacent to and disposed on either side of a bridge beam that supports an ejector element within a bubble expansion chamber below a nozzle of the printhead; and
a feed transition chamber between an ink reservoir and the feed channels, the feed transition chamber having a width that spans the feed channels and a length that exceeds the width,
wherein the feed transition chamber provides convective cooling of the printhead using ink flowing through the feed transition chamber between the ink reservoir and the pair of feed channels.

11. The printhead of claim 10, wherein both a thickness of the bridge beam and a length of the feed channels are greater than about 10 microns and less than about 100 microns.

12. The printhead of claim 10, wherein the feed transition chamber comprises opposing walls that are substantially parallel to one another.

13. The printhead of claim 10, wherein the width of the feed transition chamber is greater than a distance between opposing outer edges of the feed channels but less than about twice the distance.

14. A method of cooling a thermal inkjet printhead according to claim 1, the method comprising:
providing a feed transition chamber between an ink reservoir and a plurality of feed channels of the printhead, the feed transition chamber having both a width that spans the plurality of feed channels plus a bridge beam and a length that exceeds the width; and
flowing ink from the ink reservoir through the feed transition chamber to the plurality of feed channels,
wherein the flowing ink establishes a temperature gradient between walls of the feed transition chamber and the ink, the temperature gradient facilitating convective cooling of the printhead.

15. The method of convective cooling a printhead of claim 14, further comprising operating the printhead in a clear mode wherein a volume of a bubble formed by ejector element activation during ink ejection essentially equals a volume of an expansion chamber and a volume of a nozzle located above the bridge beam.

16. A method of cooling a printhead of a thermal inkjet system according to claim 10, the method comprising:
providing a feed transition chamber between an ink reservoir and a plurality of feed channels of the printhead, the feed transition chamber having both a width that spans the plurality of feed channels plus a bridge beam and a length that exceeds the width; and
flowing ink from the ink reservoir through the feed transition chamber to the plurality of feed channels,
wherein the flowing ink establishes a temperature gradient between walls of the feed transition chamber and the ink, the temperature gradient facilitating convective cooling of the printhead.

17. The method of convective cooling a printhead of claim 16, further comprising operating the printhead in a clear mode wherein a volume of a bubble formed by ejector element activation during ink ejection essentially equals a volume of an expansion chamber and a volume of a nozzle located above the bridge beam.
